(19) United States
(12) Patent Application Publication
(10) Pub. No.: US 2003/0158821 A1
(43) Pub. Date: Aug. 21, 2003

(54) Equivalence and data verification system

(76) Inventor: Regis Pires Maia, Passos (BR)

Correspondence Address: Peter A. Sullivan, Hughes Hubbard & Reed LLP, One Battery Park Plaza, New York, NY, 10004-1482, US

(21) Appl. No.: 10/078,249

(22) Filed: Feb. 15, 2002

(51) Int. Cl. G06F 17/60

(52) U.S. Cl. 705/75

(57) ABSTRACT

Which consists of a software programming for matching and checking of given data, either by a credit and/or debit card, or by documents such as: identity card, driver's license, passport, brevet, etc., or by electronic terminals; of passwords, fingerprint, iris data (or retina), changeable bar code, or voice in a binary language coding, with the similar stored data of the program contained in the document's or electronic terminal's card chip so that each user or institution will be able to opt for the device(s) that suit them best if the user chooses the changeable password there is a manner of using a card (1) with chip (2), or a document (identity card, driver's license, passport, brevet), with a chip or a changeable bar code equivalence, and as there be in the chip a software programming for matching and checking of given data, either by the own card, or by electronic terminals, such as: passwords, fingerprint, iris data (or retina), changeable bar code, or voice in a binary language coding, with the similar stored data of the program contained in the card's or electronic terminal's chip.

The present patent of invention deals with an Equivalence and Data Verification System, which consists of a software programming, with features for matching and checking of given data, either by a credit and/or debit card, or by documents such as: identity card, driver's license, passport, brevet, etc., or by electronic terminals; of passwords, fingerprint, iris data (or retina), changeable bar code, or voice in a binary language coding, with the similar stored data of the program contained in the document's or electronic terminal's card chip.

The various options offered by the Equivalence and Data Verification System to compare and verify data are represented on the attached and illustrative figures, to which having reference in order to better explain the detailed description that follows.

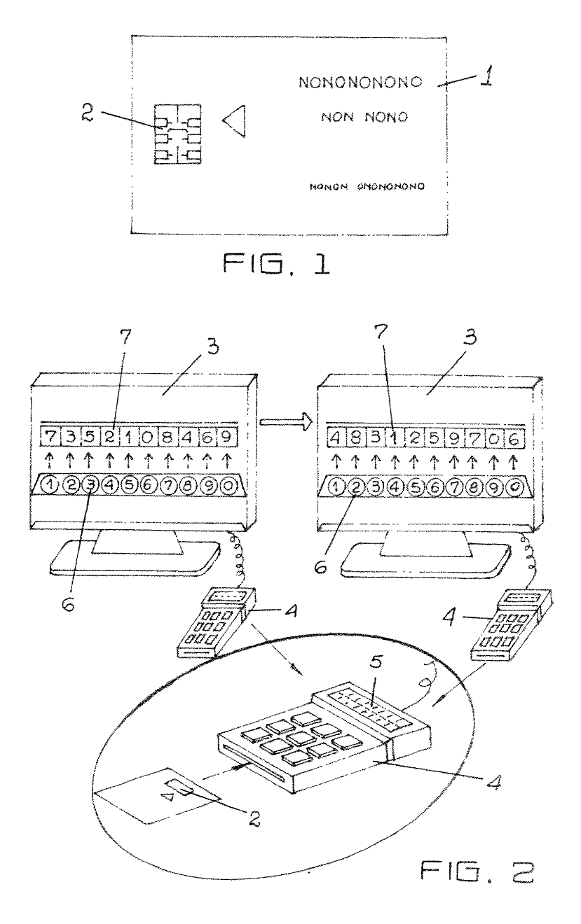

FIG. 1: Represents a card (1) with chip (2).

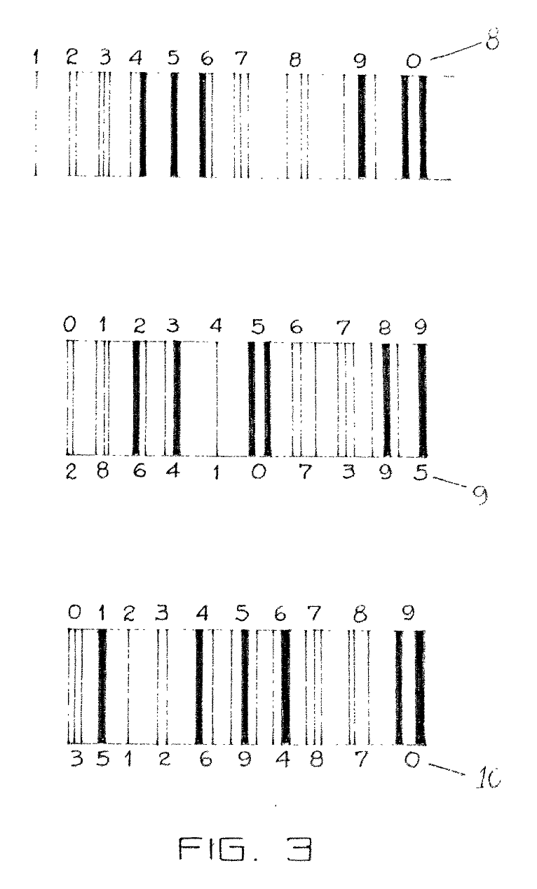

FIG. 2: Represents an electronic terminal showing the screens (3) and the reading and identification device (4) of the card's or document's chip (2) at the time is inserted or positioned, endowed with a display (5), where, on the upper part (7), it's visualized a random sequence of numbers, with one digit between 0 and 9, or

bar code, whose order is changeable each time that the card or document is set in motion, and on the lower part (6), the increasingly order between 0 and 9 or letters with an outfitted shape for each random number or the changeable bar code equivalence.

FIG. 3: It represents, by sequence, the referenced bar code (8) and further the samples of changes in the variable bar code equivalence for a card or document, each time that is set in motion (9) and (10).

Each user or institution will be able to opt for the device(s) that suit them best.

If choosing the changeable password there is a manner of using the card with a chip (FIG. 1), or a document (identity card, driver's license, passport, brevet), with a chip or a changeable bar code equivalence (9) and (10)—(FIG. 3).

In the card with a chip (FIG. 1), or documents (identity card, driver's license, passport, brevet) with a chip or a changeable bar code equivalence, this one as being inserted or positioned for reading into an electronic terminal (FIG. 2), it will open through a program stored in the chip of the card or document, or in the computer system connected to the electronic terminal, for visualization on display (screen), a random sequence of numbers, with one digit between 0 and 9, or the bar code, whose order is changeable each time that the card or document is set in motion.

The operational way to generate the random sequence of numbers with one digit between 0 and 9, with a software program, it is configurated a display with a single decimal place, to be defined, through the final numbers of a multiplication, from the numbers with one digit between 0 and 9 (with one column), sequentially predetermined upon the software program configuration, to the numbers with two digits, for the day, the month, and the last two digits corresponding to the effective year; increased of more two numbers with two digits for the hour and minute (with one line), also predetermined and located before, after or interspersed to the digits referring to the effective day, month and year (which arrangement is alike to the arrays and combinations of the mathematical matrixes).

Dealing with the combinations of letters, or making reference to the bar code, it is just putting in practice the substitution of the numbers with one digit between 0 and 9 (with one column), by the letters or equivalent numbers of the bar on the bar code, into the respective positions; upon the software program configuration, it obtains by the same way, the outcome combination from multiplying the numbers of the described and effective date, hour and minute, with one line, to the equivalent letters or number of the bar on the bar code with one column, or vice versa (similar to the mathematical matrix).

Being the random numbers, or letters or equivalent numbers of the bar on the bar code resulting from this mathematical operation, placed and outfitted in sequence which referring to an increasingly order between 0 and 9, where it will be read the fixed password; the generation of the reading is made by the positioning and equivalence that such random numbers, letters, or equivalent numbers of the bar on the bar code occupy in the decimal place that corresponds to the number of the stored fixed password, in the software program, when this one is activated (fixed password).

Corresponding to each number with one digit arranged as a random sequence, it is geometrically configured an increasingly order between 0 and 9 or letters with an outfitted shape to each random number or the changeable bar code equivalence (to see FIGS. 2 and 3).

In possession of its predeterminated, fixed and secret password, at the moment of the card or document activation, the user will go typing the cryptographic, changeable and random number, which on the screen (3) or display (5) will correspond to the number of its fixed and secret password, that is read along the increasingly order between 0 and 9, or letters, or the changeable bar code reference, geometrically set and outfitted to each random number, so that it will be always typed on the terminal (4), a cryptographic and different password, corresponding to the memorized, fixed and secret password.

The terminal will take on feedback and retransmit the cryptographic and changeable typing to the program in the card's (1), document's or the same terminal's chip (2), which will verify if that sequence of cryptographic and typed numbers comply with the numbers of the fixed password in the program.

Once confirmed, it is given access to the operation to what purpose is for, or the document's veracity certificate.

If the card's, document's and/or electronic terminal's user identification is given by the means of fingerprint, iris (or retina), voice or changeable bar code, once the data are collected and stored in a binary language into the card's, document's or electronic terminal's chip program, each time that the electronic terminal is accessed by the user, this will ask for the specified identification, and thus the card's or document's insertion or placement for reading will be requested, into the terminal's receptor for the program activation in its chip or the bar code reading and the matching of the presented data to the terminal's, along with the stored ones in the card's or document's chip binary language or the changeable bar code equivalence or, optionally, after the presentation of the user's specific identification, either by fingerprint, iris (or retina), voice or changeable bar code, the complementing of the identification will be required, by the cryptographic typing through the changeable password system, showed on the display (already described).

After the checking and determination of the data and compatibility, the opening of access to the proposed operation is carried on, or the document's veracity certificate.

1) “EQUIVALENCE AND DATA VERIFICATION SYSTEM”, described as consisting of a software programming, with features for matching and checking of given data, either by a credit and/or debit card, or by documents such as: identity card, driver's license, passport, brevet, etc., or by electronic terminals, of passwords, fingerprint, iris data (or retina), changeable bar code, or voice in a binary language coding, with the similar stored data of the program contained in the document's or electronic terminal's card chip, so that each user or institution will be able to opt for the device(s) that suit them best:

2) “EQUIVALENCE AND DATA VERIFICATION SYSTEM”, in accordance with the claim 1 and described as if the user chooses the changeable password there is a manner of using a card (1) with chip (2), or a document (identity card, driver's license, passport, brevet), with a chip or a changeable bar code equivalence.

3) “EQUIVALENCE AND DATA VERIFICATION SYSTEM”, in accordance with the claim 1 and described as in the card with a chip, or documents (identity card, driver's license, passport, brevet) with a chip or a changeable bar code equivalence, this one as being inserted or positioned for reading into an electronic terminal, it will open through a program stored in the chip of the card or document, or in the computer system connected to the electronic terminal, for visualization on display (screen), a random sequence of numbers, with one digit between 0 and 9, or the bar code, whose order is changeable each time that the card or document is set in motion, so that corresponding to each number with one digit arranged as a random sequence, it is geometrically configured an increasingly order between 0 and 9 or letters with an outfitted shape to each random number or the changeable bar code equivalence.

4) “EQUIVALENCE AND DATA VERIFICATION SYSTEM”, in accordance with the claim 1 and described as the operational way to generate the random sequence of numbers with one digit between 0 and 9, with a software program, it is configurated a display with a single decimal place, to be defined, through the final numbers of a multiplication, from the numbers with one digit between 0 and 9 (with one column), sequentially predetermined upon the software program configuration, to the numbers with two digits, for the day, the month, and the last two digits corresponding to the effective year; increased of more two numbers with two digits for the hour and minute (with one line), also predetermined and located before, after or interspersed to the digits referring to the effective day, month and year (which arrangement is alike to the arrays and combinations of the mathematical matrixes) and dealing with the combinations of letters, or making reference to the bar code, it is just putting in practice the substitution of the numbers with one digit between 0 and 9 (with one column), by the letters or equivalent numbers of the bar on the bar code, into the respective positions; upon the software program configuration, it obtains by the same way, the outcome combination from multiplying the numbers of the described and effective date, hour and minute, with one line, to the equivalent letters or number of the bar on the bar code with one column, or vice versa (similar to the mathematical matrix) and being the random numbers, or letters or equivalent numbers of the bar on the bar code resulting from this mathematical operation, placed and outfitted in sequence which referring to an increasingly order between 0 and 9, where it will be read the fixed password; the generation of the reading is made by the positioning and equivalence that such random numbers, letters, or equivalent numbers of the bar on the bar code occupy in the decimal place that corresponds to the number of the stored fixed password, in the software program, when this one is activated (fixed password).

5) “EQUIVALENCE AND DATA VERIFICATION SYSTEM”, in accordance with the claim 1 and described as the user in possession of its predeterminated, fixed and secret password, at the moment of the card or document activation, will go typing the cryptographic, changeable and random number, which on the display will correspond to the number of its fixed and secret password, that is read along the increasingly order between 0 and 9, or letters, or the changeable bar code reference, geometrically set and outfitted to each random number, so that it will be always typed on the terminal (4), a cryptographic and different password, corresponding to the memorized, fixed and secret password; and the terminal retransmits on feedback the cryptographic and changeable typing to the program in the card's (1), document's or the same terminal's chip (2), which will verify if that sequence of cryptographic and typed numbers comply with the numbers of the fixed password in the program so that once confirmed, it is given access to the operation to what purpose is for, or the document's veracity certificate.

6) “EQUIVALENCE AND DATA VERIFICATION SYSTEM”, in accordance with the claim 1 and described as if the card's, document's and/or electronic terminal's user identification is given by the means of fingerprint, iris (or retina), voice or changeable bar code, once the data are collected and stored in a binary language into the card's, document's or electronic terminal's chip program, each time that the electronic terminal is accessed by the user, this will ask for the specified identification, and thus the card's or document's insertion or placement for reading the bar code, card or document will be requested, into the terminal's receptor for the program activation in its chip or the bar code reading and the matching of the presented data to the terminal's, along with the stored ones in the card's or document's chip binary language or the changeable bar code equivalence or, optionally, after the presentation of the user's specific identification, either by fingerprint, iris (or retina), voice or changeable bar code, the complementing of the identification will be required, by the cryptographic typing through the changeable password system, showed on the display, so that after the checking and determination of the data and compatibility, the opening of access to the proposed operation is carried on, or the document's veracity certificate.
